(19) United States
(12) Patent Application Publication
(10) Pub. No.: US 2007/0151818 A1
(43) Pub. Date: Jul. 5, 2007

(54) Electromechanically actuated parking brake

(75) Inventors: Paul Linhoff, Neu-Anspach (DE); Jochen Thiesing, Mainz-Kastel (DE); Jurgen Balz, Hunstetten-Oberlibbach (DE); Enrico Ruck, Taucha (DE); Samir Attayebi, Frankfurt/M. (DE); Jurgen Volkel, Frankfurt/M. (DE); Rolf Weiler, Eppstein (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/587,063

(22) PCT Filed: Oct. 29, 2004
(86) PCT No.: PCT/EP04/52735

§ 371 Date: Jul. 21, 2006

(30) Foreign Application Priority Data
Jan. 21, 2004 (DE) 10 2004 003 248.3
Apr. 29, 2004 (DE) 10 2004 021 284.8
Oct. 8, 2004 (DE) 10 2004 049 434.7

(51) Int. Cl. B60L 7/00

(52) U.S. Cl. 188/326; 188/265; 188/162

(57) ABSTRACT

Disclosed is an electromechanically actuated parking brake for motor vehicles that is designed as a drum brake of the ‘Duo-Servo’ type, including a floatingly supported expanding lock which is operable by an electromechanical actuator arranged on a wheel carrier, and which is essentially composed of a threaded-nut/spindle assembly, the threaded nut of which is driven by the electromechanical actuator, and of two thrust members. At least one spring element is provided in the flux of force between the threaded-nut/spindle assembly and at least one of the thrust members. This provision allows compensating losses of application force, while the set application force is maintained in a reliable manner.

### BACKGROUND OF THE INVENTION

The present invention relates to an electromechanically actuated parking brake for motor vehicles that is designed as a drum brake of the ‘Duo-Servo’ type, including a floatingly supported expanding lock which is operable by an electromechanical actuator arranged on a wheel carrier, and which is essentially composed of a threaded-nut/spindle assembly, the threaded nut of which is driven by the electromechanical actuator, and of two thrust members.

International application WO 2004/059189 A1 discloses an electromechanically operable parking brake of this type. In the prior art parking brake, the floating support of the expanding lock is realized in that the threaded nut has a spur toothing which forms a skew gear system along with a spiral-toothed gear wheel or a spur gear system along with a gear wheel, respectively. When the parking brake of an automotive vehicle parked on a slope is activated, the automotive vehicle will slightly move in the direction of the slope-downhill force until the brake shoes are in engagement with the brake drum and a support on the wheel carrier, which is due to the self-energizing effect being characteristic of drum brakes of the ‘Duo-Servo’ type. With these effects, lost travel occurs within the expanding lock, which—due to the rigidity of the components disposed in the flux of force—causes an immediate loss in expanding force and, thus, reduces the application force, which can lead to safety-critical situations. Besides, it may happen in the prior art parking brake that release of the parking brake is no longer possible. When the brake drum that has previously been heated cools down, it is exposed to an insignificant shrinking process, whereupon the application force increases due to the already mentioned great rigidity of the components being in the flux of force. The increase of the application force, which has just been described, renders it possible that release of the parking brake cannot be performed, which has to be considered disadvantageous.

In view of the above, an object of the invention involves improving an electromechanically operable parking brake of the type mentioned hereinabove to such an end that the adjusted application force is reliably maintained during a parking brake operation irrespective of any outside influences.

### SUMMARY OF THE INVENTION

According to the invention, this object is achieved in that at least one spring element is provided in the flux of force between the threaded-nut/spindle assembly and at least one of the thrust members.

To render the subject matter of the invention more precise, provisions are made for the spring element to be arranged between the thrust member and a thrust collar cooperating with the threaded nut.

In an especially favorable improvement of the object of the invention, an axial mounting support of the threaded nut is provided in the housing of the expanding lock.

The axial mounting support is then designed as a calotte-type bearing which is formed either by a ball and a ball socket or by a calotte-type component and a concave bearing part. The concave bearing part includes an axial extension, which projects into a blind-end bore of the spindle.

It is provided that the threaded nut is supported on the thrush member by way of the spring element, the thrust collar, and the calotte-type bearing.

In an especially favorable embodiment of the object of the invention, the thrust member, the spring element, and the thrust collar form an independently manageable subassembly.

In another favorable design, the spring element is formed of at least one cup spring.

### BRIEF DESCRIPTION OF THE DRAWINGS

The invention will be explained in detail in the following by way of two embodiments, making reference to the accompanying drawings. In the drawings:

FIG. 1 is a simplified view of a first embodiment of the parking brake of the invention;

FIG. 2 is a cross-sectional view of an expanding lock, which can be mounted into the parking brake illustrated in FIG. 1;

FIG. 3 is a cross-sectional view of a second design of the expanding lock illustrated in FIG. 2.

### DETAILED DESCRIPTION OF THE DRAWINGS

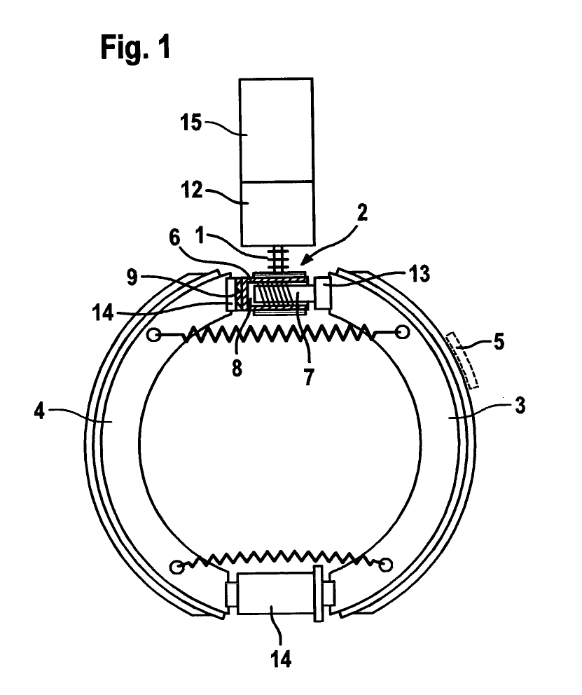

The electromechanically operable parking brake of the invention, as shown in FIG. 1, essentially comprises a per se known drum brake of the ‘Duo-Servo’ type and an electromechanical actuator 15. The drum brake of the ‘Duo-Servo’ type includes a brake drum 5 (shown only in part), a pair of brake shoes 3, 4 furnished with friction surfaces, and an expanding lock 2 that can move the friction surfaces of the brake shoes 3, 4 into engagement with the inside surface of the brake drum 5. Characteristic of the drum brake of the ‘Duo-Servo’ type is a freely movable or floatingly mounted supporting device 14 which is opposite to the expanding lock 2 and arranged between the brake shoes 3, 4. Further, the supporting device 14 is combined with a readjusting device.

The expanding lock 2 mentioned hereinabove is essentially formed of a threaded-nut/spindle assembly 8 and two thrust members 13, 14, the one thrust member 13 thereof cooperating with the spindle 7, while the other thrust member 14 cooperates with the threaded nut 6. As is illustrated in FIG. 1, the threaded-nut/spindle assembly 8 is actuated by a

spiral-toothed gear wheel 1, which is driven by the electromechanical actuator 15 by way of a reduction gear 12 that is not described in detail. To this end, the threaded nut 6 includes a toothed system on its outward surface extending in parallel to the axis of the threaded nut 6. With this spur toothing on the threaded nut 6, the above-mentioned spiral-toothed gear wheel 1 forms a skew gear system. The threaded nut 6 is induced to perform a rotational movement when the spiral-toothed gear wheel 1 is actuated by the electromechanical actuator 15. Due to this rotational movement of the threaded nut 6, the spindle 7 of the threaded-nut/spindle assembly 8 performs a translational motion and urges the two brake shoes 3, 4 with the desired application force into engagement with the brake drum 5.

In order to carry out a parking brake operation, either the reduction gear 12 or the threaded-nut/spindle assembly 8 has a self-locking design. This measure causes the brake shoes 3, 4 to remain in engagement with the brake drum 5 in the de-energized condition of the electromechanical actuator 15.

If the automotive vehicle is parked on a slope, the adjustment of the desired application force will be followed by an insignificant movement of the automotive vehicle in the direction of the downhill-slope force. As this occurs, the brake drum 5 also rotates by a defined amount of angle until the self-energizing effect commences that is characteristic of a drum brake of the ‘Duo-Servo’ type. However, the desired application force consequently reduces. For this reason, the invention provides that a spring element 9 is arranged in the flux of force between the threaded-nut/spindle assembly 8 and the thrust member 14 cooperating with the threaded nut 6, the said spring element compensating the above-described reduction of the desired application force. It is further possible that release of the parking brake cannot be performed when the previously heated brake drum 5 cools down. In this cooling process, the brake drum 5 undergoes a certain shrinking action, whereupon the application force increases due to the great rigidity of the components being in the flux of force. It is possible in this case that the electromechanical actuator 15 cannot perform release of the parking brake, because the application force is too high and the components being in the flux of force got jammed. The above-mentioned arrangement of the invention, as illustrated in FIG. 1, prevents this effect as well.

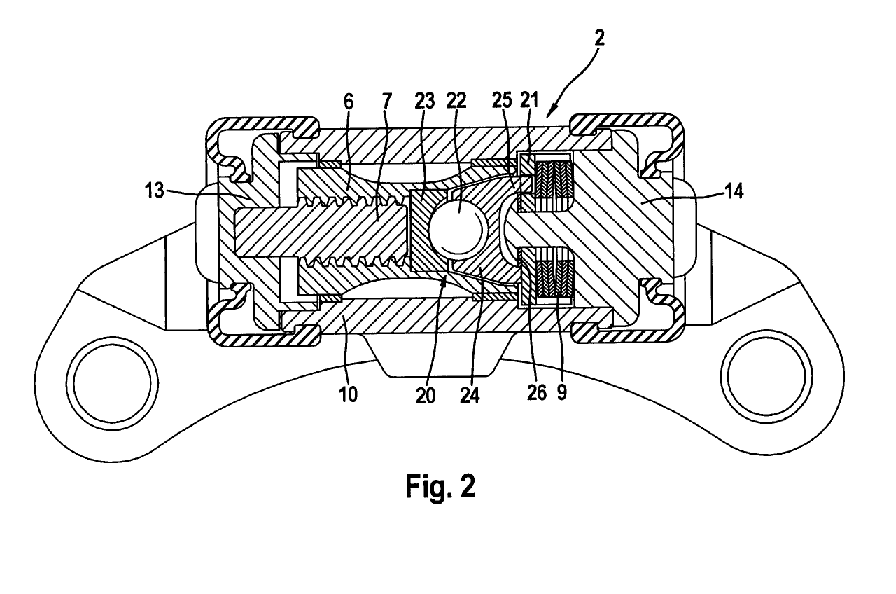

As apparent from FIG. 2 showing the expanding lock 2, the spring element 9 is arranged between the thrust member 14 cooperating with the threaded nut 6 and a thrust collar 21 cooperating with the threaded nut 6. The threaded nut 6 is pivoted in a housing 10 of the expanding lock 2 with the aid of a calotte-type bearing 20. The spur toothing on the outside surface of the threaded nut 6 is not shown. As soon as the electromechanical actuator drives the spiral-toothed gear wheel (not shown) being in engagement with the threaded nut 6, the threaded nut 6 will be moved to rotate, as has already been described. As a result, the spindle 7 performs a translational motion to the left, as viewed in the drawing, urging the thrust member 13 to the left, as viewed in the drawing, whereupon the first brake shoe (not shown in FIG. 2) is urged against the brake drum (not shown). The application force thereby achieved is supported on the thrust member 14 cooperating with the threaded nut 6 by way of the spindle 7, the threaded nut 6, the calotte-type bearing 20, and by way of the spring element 9. As a reaction, the second brake shoe is also urged against the brake drum, and the expanding lock 2 centers itself inside the brake drum. The spring element 9 is compressed or charged, respectively, during this action.

The axial mounting support of the threaded nut 6 by means of the previously mentioned calotte-type bearing 20 is especially favorable because transverse forces cannot damage the calotte-type bearing 20 and cannot act on the thread between the threaded nut 6 and the spindle 7, which would otherwise be subjected to major wear. The above-mentioned transverse forces basically result from a possible tilting of the thrust member 14.

In the embodiment illustrated in FIG. 2, the calotte-type bearing is formed of a ball 22 and a hardened ball socket 23, the diameters of which are different. As a result, the friction moments are comparatively small. The above-mentioned ball 22 is retained by a ball accommodation 24 embracing the ball. On its side remote from the ball 22, the ball accommodation 24 includes several fingers 25, which are mounted in the above-mentioned thrust collar 21 and this way establish the flux of force between the threaded nut 6 and the thrust member 14 by way of the calotte-type bearing 20 and the spring element 9. Besides, it can be seen in FIG. 2 that the thrust member 14 cooperating with the threaded nut 6, the spring element 9, and the thrust collar 21 form an independently manageable subassembly with the aid of a disc 26. Alternatively, it is possible to add the ball accommodation 24 including the ball 22 to the previously mentioned independently manageable subassembly.

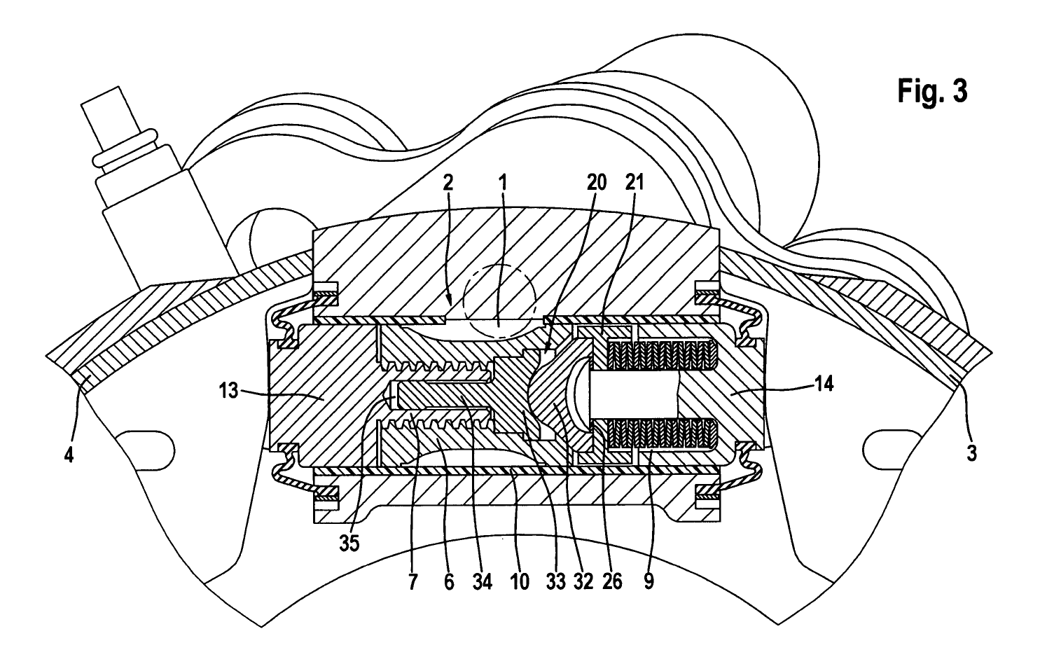

FIG. 3 shows a second embodiment of the expanding lock 2. The housing 10 of the expanding lock 2 accommodates the threaded nut 6 and the spindle 7 as well as the two thrust members 13, 14. As has been described with respect to FIG. 2, the threaded nut 6 is induced to rotate by the spiral-toothed gear wheel 1, which is only indicated in a cross-section in FIG. 3. As a result, the spindle 7 performs a translational motion to the left, as viewed in the drawing, urging the brake shoe 4 against the brake drum (not shown), whereupon also the opposite brake shoe 3 is moved to abut on the inside surface of the brake drum as a reaction. The expanding lock 2 centers itself inside the brake drum and the spring element 9 is compressed or charged, respectively, during this action.

The axial mounting support of the threaded nut 6 is also realized by a calotte-type bearing 20 in the embodiment illustrated in FIG. 3. However, in contrast to the embodiment shown in FIG. 2, the calotte-type bearing 20 is formed of a calotte-type component 32 and a concave bearing part 33. The concave bearing part 33 is rigidly connected to the threaded nut 6 and has an axial extension 34 projecting into a blind-end bore 5 of spindle 7. The calotte-type component 32 is mounted to fit in the thrust collar 21 and forms with it and with the spring element 9 and the thrust member 14 an independently manageable subassembly. For this purpose, the thrust member 14 forms a hat-shaped recess in which the spring element 9 is arranged. A component for riveting the components is provided in the middle of the hat-shaped recess.

Preferably, the spring element 9 is formed of one or more cup springs in the preferred embodiments.

1-9. (canceled)

10. An electromechanically actuated parking brake for motor vehicles that is designed as a drum brake of the ‘Duo-Servo’ type, the parking brake comprising:
a floatingly supported expanding lock (2) which is operable by an electromechanical actuator (15) arranged on a wheel carrier, wherein the expanding lock includes a threaded-nut/spindle assembly (8) and the threaded nut (6) is driven by the electromechanical actuator (15), and of two thrust members (13, 14); and
at least one spring element (9) is provided in a flux of force between the threaded-nut/spindle assembly (8) and at least one of the thrust members (13, 14).

11. An electromechanically actuated parking brake according to claim 10, wherein the spring element (9) is arranged between the thrust member (14) and a thrust collar (21) cooperating with the threaded nut (6).

12. An electromechanically actuated parking brake according to claim 11, wherein the thrust member (14), the spring element (9), and the thrust collar (21) form an independently manageable subassembly.

13. An electromechanically actuated parking brake according to claim 10, wherein an axial mounting support of the threaded nut (6) is provided in a housing (10) of the expanding lock (2).

14. An electromechanically actuated parking brake according to claim 13, wherein the axial mounting support is designed as a calotte-type bearing (20).

15. An electromechanically actuated parking brake according to claim 14, wherein the calofte-type bearing (20) is formed of a calotte-type component (32) and a concave bearing part (33) which includes an axial extension (34) projecting into a blind-end bore (35) of the spindle (7).

16. An electromechanically actuated parking brake according to claim 14, wherein the calotte-type bearing (20) is formed of a ball (22) and a ball socket (23).

17. An electromechanically actuated parking brake according to claim 14, wherein the threaded nut (6) is supported on the thrust member (14) by way of the spring element (9), the thrust collar (21), and the calotte-type bearing (20).

18. An electromechanically actuated parking brake according to claim 10, wherein the spring element (9) is formed of at least one cup spring.
